(19) United States
(12) Patent Application Publication
(10) Pub. No.: US 2020/0265396 A1
(43) Pub. Date: Aug. 20, 2020

(54) SYSTEMS AND METHODS FOR MODIFYING CUSTOMER ATTENTION LEVELS AT PURCHASE TRANSACTION TERMINALS BASED ON EXPRESSIONS

(71) Applicant: Toshiba Global Commerce Solutions Holdings Corporation, Tokyo (JP)

(72) Inventors: Jason Chirakan, Research Triangle Park, NC (US); Jon Meulenberg, Research Triangle Park, NC (US); Phillip Monkowski, Research Triangle Park, NC (US)

(21) Appl. No.: 16/275,526

(22) Filed: Feb. 14, 2019

(51) Int. Cl. G06Q 20/18; G06Q 20/40; G06Q 20/20; G06K 9/00

(52) U.S. Cl. CPC G06Q 20/18; G06K 9/00302; G06Q 20/206; G06Q 20/4016

(57) ABSTRACT

Systems and methods for modifying customer attention levels at purchase transaction terminals based on expressions are disclosed. According to an aspect, a method includes acquiring one or more images of a person at a purchase transaction terminal. The method also includes analyzing the image(s) to determine an expression of the person. Further, the method includes determining whether the determined expression matches a predetermined expression. The method also includes modifying a customer attention level associated with the purchase transaction terminal in response to determining that the determined expression matches the predetermined expression.

### TECHNICAL FIELD

The presently disclosed subject matter relates generally to retail systems and equipment. Particularly, the presently disclosed subject matter relates to systems and methods for modifying customer attention levels at purchase transaction terminals based on expressions.

### BACKGROUND

In retail environments, such as grocery stores and other “brick and mortar” stores, customers typically shop within a store and subsequently proceed to checkout for purchase of items at a point of sale (POS) terminal. The POS terminal may operate to conduct a self-checkout purchase transaction with the customer, or the POS terminal may operate to conduct a purchase transaction with the customer with assistance of store personnel. Such purchase transactions typically involve scanning a bar code of each item for purchase by the customer in order to calculate and display a total amount owed by the customer for the products. Subsequently, a purchase transaction for the customer may be completed after entry of payment information by the customer or store personnel.

At the point of checkout at a POS terminal, some customers may attempt to steal one or more items. For example, at a self-checkout terminal, a customer may attempt to pay for some items and not pay for others. At some self-checkout terminals, there are some security measures in place to prevent such actions. For examples, the system may estimate a weight of items scanned for purchase by the customer. This estimated weight can be compared to an actual weight of items placed at a bagging area. If there is too much difference in weight, then a notification may be sent to personnel of the retail store. However, despite such efforts, there is a continuing need to prevent or discourage theft.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of a purchase transaction system or point-of-sale system according to embodiments of the present disclosure;

FIG. 2 is a flow chart of an example method for modifying customer attention levels at purchase transaction terminals based on expressions in accordance with embodiments of the present disclosure;

FIG. 3 is a flow chart of another example method for modifying customer attention levels at purchase transaction terminals based on expressions in accordance with embodiments of the present disclosure; and

FIG. 4 is a perspective view of an example checkout area with a POS terminal for determining a likelihood of intended purchase of items and for presenting related information to users in accordance with embodiments of the present disclosure.

### SUMMARY

The presently disclosed subject matter provides systems and methods for modifying customer attention levels at purchase transaction terminals based on expressions. According to an aspect, a method includes acquiring one or more images of a person at a purchase transaction terminal. The method also includes analyzing the image(s) to determine an expression of the person. Further, the method includes determining whether the determined expression matches a predetermined expression. The method also includes modifying a customer attention level associated with the purchase transaction terminal in response to determining that the determined expression matches the predetermined expression.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present disclosure. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

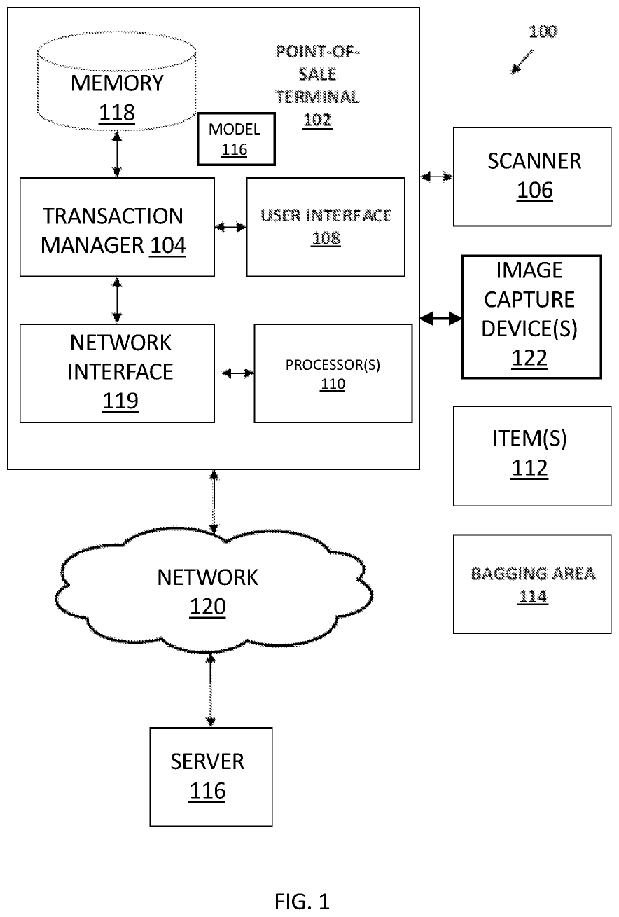

FIG. 1 illustrates a block diagram of a purchase transaction system or point-of-sale (POS) system 100 according to embodiments of the present disclosure. Referring to FIG. 1, the system 100 may be implemented in whole or in part in any suitable environment for conducting purchase transactions. For example, the system 100 may be implemented in any retail store (e.g., a hardware store or grocery store) that can use a POS terminal. The system 100 may include a POS terminal 102 that may include a transaction manager 104, such as a POS application. The POS terminal 102 may be communicatively coupled to a scanner 106, and a user interface 108. The transaction manager 104 may be an application that executes on one or more processors 110 of the POS terminal 102. The processor(s) 110 may be, for example, a dual processor which includes a graphical processing unit (GPU) for rendering multiple different static images and/or pixel frames of video data. The POS terminal 102 may include any suitable hardware, software, and/or firmware for implementing functions and processes in accordance with embodiments of the present disclosure. The system 100 may include any number of transaction terminals, and only one transaction terminal is shown in FIG. 1 for convenience of illustration.

The scanner 106 may be capable of reading a machine-readable image representing data from one or more item(s) 112 for purchase. The scanner 106 may be a handheld device that can be passed over a barcode (e.g., a universal product code (UPC) or any other machine-readable image) on one of the items 112 or may be built into a counter or platform whereby products are passed over the scanner. Further, the scanner 106 may read data from purchase items and transmit the data to the transaction terminal 102 via, for example, a wireless or wireline connection. In an example, the machine-readable image on the item(s) 112 may represent identification of the purchase item. Identification of the item may alternatively be provided to the transaction terminal by, for example, a user entering an identifier, such as a number, representing the item. The identification may be used for accessing data associated with the purchase item, such as, but not limited to, information for determining a category or pricing of the item 112. In a purchase transaction, the identifications of multiple items may be obtained in this way, and the identifications may be communicated to the purchase analyzer 104 as items are scanned.

The user interface 108 may include a keyboard device or touch display that enables a shopper or retail personnel, such as a cashier, to input information and to be presented with information or graphics related to a purchase transaction. For example, a shopper may input account and payment information for processing by the POS terminal 102. The user interface 108 may include a scanning device with a keypad for reading a shopper's financial card (e.g., credit card or debit card) including account number. The user interface 108 may be rendered on a display (not shown) attached to the POS terminal 102. The keypad device on the financial card scanning device may enable a shopper to enter a personal identification number (PIN) if using a debit card or other financial card that requires the PIN be entered. The user interface 108 may include the display for displaying purchase and transaction information to the shopper. For example, the user interface 108 may be a touchscreen display for displaying text and graphics and for receiving user input. The user interface 108 may be communicatively coupled to the POS terminal 102 via wireless or wireline elements.

The scanner 106 may be configured to read a machine-readable image representing an identifier of an item. The bagging area 114 may be an area associated with the POS terminal 102 in which the user bags or packages the item 112 when conducting a purchasing transaction or activity. For example, retail personnel or a customer may bag items at the bagging area 114. The scanner 106 may be used to scan the barcode of the coupon to apply a discount to a purchase transaction.

The system 100 includes one or more image capture devices 122 configured to capture images around an area of the POS terminal 102. As an example, an image capture device may be a video camera or a still camera for capturing multiple still images or video of the POS terminal area over a period of time, such as during a purchase transaction occurring at the POS terminal 102. The image capture device(s) 122 may be positioned to capture an image or video of a customer and/or retail personnel at or near the POS terminal 102. The image capture device(s) 122 may be suitably positioned to capture the image or video of the actions, such as facial expressions, of the customer and/or retail personnel during a purchase transaction. Further, the image capture device(s) 122 may be communicatively connected to the POS terminal 102, and controlled by the POS terminal 102. For example, the transaction manager 104 of the POS terminal 102 may control the image capture device(s) 122 and receive data of the images and/or video captured by the image capture device(s) 122.

In accordance with embodiments, the transaction manager 104 can determine an expression of a person based on one or more images or video captured of the person. The captured image or video may be of a customer located at or near the POS terminal 102 while conducting a purchase transaction. The POS terminal 102 may be a self-checkout terminal, a kiosk, or retail personnel-assisted checkout terminal where retail personnel assists the customer with the purchase transaction. The transaction manager 104 may determine whether the determined expression matches a predetermined expression, such as a guilty expression, a scared expression, and a confused expression. The predetermined expressions may be used as indicators of a possible intent of the customer or a possible past action of the customer. The transaction manager 104 may modify a customer attention level associated with the POS terminal 102 in response to determining that the determined expression matches the predetermined expression (i.e., the customer's expression is determined to be either a guilty, scared, or confused expression). The POS terminal 102 and/or another device may implement actions based on the customer attention level. Example actions include, but are not limited to, requesting assistance for the customer, halting the purchase transaction at the POS terminal, notifying retail personnel, and changing criteria for completing the customer's purchase transaction.

As referred to herein, the term “microexpression” can be minute or small involuntary or voluntary physical change or changes to a person's face that can be indicative of a mood, feeling, or intention of the individual. As an example, a microexpression can be a result of a voluntary and an involuntary emotional response occurring simultaneously and conflicting with one another. A microexpression may occur when the amygdala (i.e., the emotion center of the brain) responds appropriately to the stimuli that the individual experiences and the individual wishes to conceal this specific emotion. An image capture device can be used to capture images of an individual's face for detecting microexpressions. A computing device or other suitable hardware, software, firmware, or combinations thereof may be used to analyze the captured images for determining the individual's microexpression. Example emotions that may be determined from a microexpression include, but are not limited to, anger, fear, sadness, happiness, contempt, and surprise, amusement, embarrassment, anxiety, guilt, pride, relief, contentment, pleasure, confusion, and shame. A microexpression may last less than 0.25 seconds. Because they indicate a suppressed emotion, a microexpression may be used to determine an ulterior motive such as honesty, dishonesty, or an intention to not adequately pay for items.

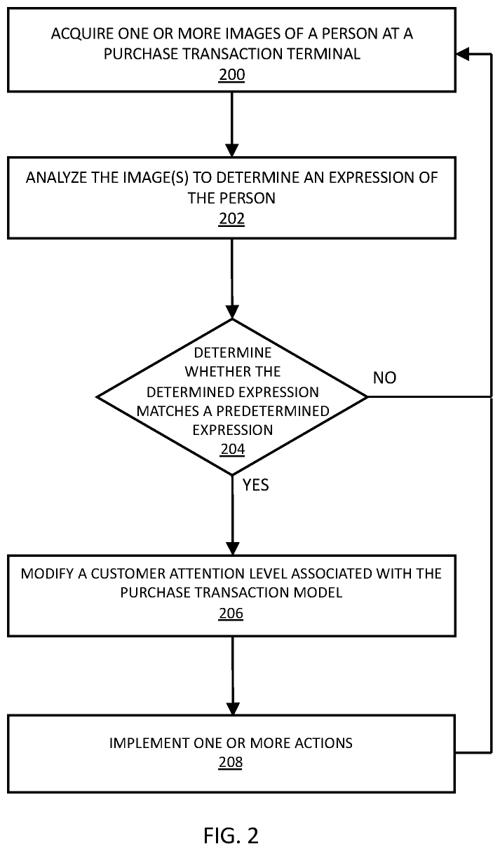

FIG. 2 illustrates a flow chart of an example method for modifying customer attention levels at purchase transaction terminals based on expressions in accordance with embodiments of the present disclosure. The method of FIG. 2 is described by example as being implemented by the system 100 shown in FIG. 1, although it should be understood that the method may alternative be implemented by any other suitable POS system. In particular for example, the transaction manager 104 of the POS terminal 102 is described as implementing the steps of the method; however, any suitable hardware, software, firmware or combinations thereof as components of a computing device or multiple computing device may implement the steps of the method or the functionality described herein for the transaction manager 104.

Referring to FIG. 2, the method includes acquiring 200 one or more images of a person at a purchase transaction terminal. For example, one or more of the image capture devices 102 (e.g., a video camera) shown in FIG. 1 may be used to capture video or one or more still images of a facial expression made by a customer at the POS terminal 102 during a purchase transaction. In this example, the image capture device(s) 122 may be configured to capture video or still images of sufficiently high resolution, such that microexpressions of the customer can be determined. The image capture device(s) 122 may communicate the captured video or images to the transaction manager 104. The transaction manager 104 may store the captured video or image data in memory 118. In this example, the image capture device(s) 122 may be mounted to or otherwise attached to the POS terminal, such as on a display or a user interface of the POS terminal. Alternatively, the image capture device(s) 102 may be attached elsewhere in the retail environment, such as attached to the ceiling. The image capture device(s) 122 may suitably communicate with the POS terminal 102, such as by a wired or wireless connection.

The method of FIG. 2 includes analyzing 202 the image(s) to determine an expression of the person. Continuing the aforementioned example, the transaction manager 104 may analyze the captured video or image data from the image capture device(s) 122 to determine an expression of the customer and/or retail personnel. The determined expression may be a microexpression of the customer at the POS terminal 102. In this example, the POS terminal 102 is a self-checkout terminal; although it is noted that this functionality may be implemented any other suitable POS terminal, such as a kiosk or a retail personnel-assisted checkout terminal. The transaction manager 104 at the POS terminal 102 or suitable equipment at another computing device may determine a microexpression of the customer based on the video or image(s) of the face of the customer. For example, the transaction manager 104 may detect, in the acquired video or image(s) of the customer's face, eye dilation, muscle movement, eye movement, or other movements of the face to determine the microexpression of the customer. Example microexpressions of interest to a retailer when a customer is conducting a purchase transaction include, but are not limited to, a guilty expression, a scared expression, or a confused expression.

Any suitable technique may be used for determining a microexpression of an individual. For example, muscle groups in one's face that are responsible for facial expressions can be identified in the captured images or video. The transaction manager 104 may identify the muscle group and their intensity level. As an example, an intensity level of a muscle group may be one of the following: trace; slight; pronounced; severe; or max. These may be used to determine the microexpression of the individual. As an example, the emotional state “confusion” may be correlated with the the person's brow being lower (e.g., at “severe”) and an eyelid being tighter (e.g., at “severe” or “max”).

The method of FIG. 2 includes determining 204 whether the determined expression matches a predetermined expression. Continuing the aforementioned example, the transaction manager 104 may store in memory 118 or elsewhere identification of expressions of interest to the retailer. The expressions of interest may include an indication of honesty, dishonesty, or an intention to not adequately pay for items. Other expressions may be specifically excluded from the database and the transaction manager 104 may be configured to specifically not determine such expressions in order to safeguard privacy and security interests of the customer. The transaction manager 104 may determine whether the expression determined for the customer matches one of the predetermined expression identified in the memory 118 that is of interest to the retailer. For example, a determination that the customer made a microexpression indicting possible honesty, dishonesty, or an intention to not adequately pay for items may be determined to be a match.

The method of FIG. 2 includes modifying 206 a customer attention level associated with the purchase transaction terminal in response to determining that the determined expression matches the predetermined expression. Continuing the aforementioned example, the transaction manager 104 may increase or decrease a customer attention level in response to determining that the expression of the customer is determined as being indicative of honesty, dishonesty, or an intention to not adequately pay for items. A customer attention level may be, for example, an indicator of a level of service or actions to take for a customer conducting a purchase transaction at a particular POS terminal. For example, at the beginning of a purchase transaction, the customer attention level may be set at zero (0) to indicate that a normal level of service or actions are to be taken for the customer. Examples include steps required to complete the purchase transaction (e.g., additional security steps or a requirement to present identification such as a driver's license) or whether to notify retail personnel to assist the customer. The attention level can be raised if incorrect actions are taken during a transaction, such as not placing items in correct location or placing an incorrect item in or on a security device. The attention level can also be decreased if corrective actions are taken, such as removing an incorrect item and replacing it with the correct item, or if multiple correct actions were done subsequently. Certain determined microexpressions (e.g., those indicating dishonesty or an intention to not adequately pay for items) may cause the customer attention level to increase such that actions or notifications may be implemented. Certain other determined microexpressions (e.g., those indicating honesty) may cause the customer attention level to decrease such that actions or notifications are no longer made. If it is determined by the transaction manager 104 that the determined expression does not match the predetermined expression, the method may return to step 200.

Subsequent to step 206, the method includes implementing 208 one or more actions associated with the modified customer attention level. Continuing the aforementioned example, the transaction manager 104 may send a notification to an operator (e.g., a retail store manager or other personnel) based on the modified customer attention level of the customer. In an example, the notification may be a request for the operator to assist the customer or check items being purchased by the customer. In another example, the transaction manager 104 may increase a requirement for completing a purchase transaction by the customer (e.g., in the instance that it is determined the customer has a guilty expression). Multiple stages of expressions can also be acted upon properly, for example, if microexpressions of confusion corresponding with an attention level over a predetermined limit changing to microexpressions of confidence corresponding with an unchanged attention level over the course of the transaction may cause the operator to forgo intervening in the transaction. Subsequent to implementing the action(s), the method may return to step 200.

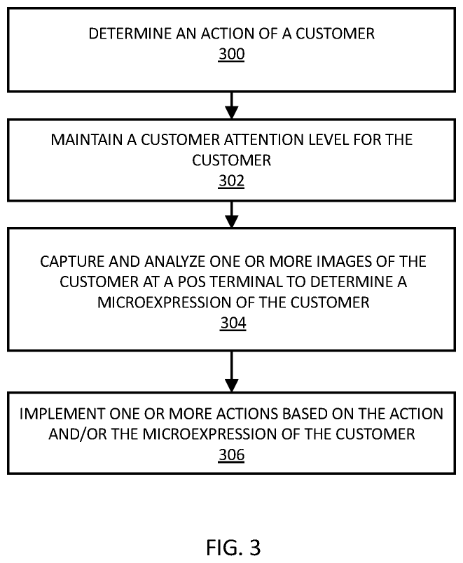

FIG. 3 illustrates a flow chart of another example method for modifying customer attention levels at purchase transaction terminals based on expressions in accordance with embodiments of the present disclosure. The method of FIG. 3 is described by example as being implemented by the system 100 shown in FIG. 1, although it should be understood that the method may alternative be implemented by any other suitable POS system. In particular for example, the transaction manager 104 of the POS terminal 102 is described as implementing the steps of the method; however, any suitable hardware, software, firmware or combinations thereof as components of a computing device or multiple computing device may implement the steps of the method or the functionality described herein for the transaction manager 104.

Referring to FIG. 3, the method includes determining 300 an action of a customer. For example, the POS terminal 102 shown in FIG. 1 may be a self checkout terminal. A customer may arrive at the POS terminal 102 with items for purchase. Further, the customer may scan the items and place them one-by-one in the bagging area 114, which is configured to weigh items in the bagging area and provide an indication of the weight to the transaction manager 104. The transaction manager 104 may receive the weight of the items and determine whether they match or closely match the scanned items. If the weight does not match an expected weight for the scanned items, then the transaction manager 104 may increase a customer attention level for the customer.

At step 302 of FIG. 3, the method includes maintaining the customer attention level for the customer. Continuing the aforementioned example, the transaction manager 104 may maintain the customer attention level. For example, the customer attention level may be modified (increased or decreased based on an action at step 300 (e.g., weight in the bagging area 114 does not match scanned items)) or kept the same.

The method of FIG. 3 includes capturing and analyzing 302 one or more images of the customer at the POS terminal to determine a microexpression of the customer. Continuing the aforementioned example, the image capture device(s) 102 shown in FIG. 1 may capture video or one or more still images of a facial expression made by a customer at the POS terminal 102 during a purchase transaction. The transaction manager 104 may analyze the captured video or image data from the image capture device(s) 122 to determine a microexpression of the customer at the POS terminal 102.

The method of FIG. 3 includes implementing 306 one or more actions based on the action by the customer and/or the microexpression of the customer. Continuing the aforementioned example, the transaction manager 104 may send a notification to a retail store personnel based on the modified customer attention level of the customer. In an example, the notification may be a request for the retail store personnel to assist the customer or check items being purchased by the customer. In another example, the transaction manager 104 may increase a requirement for completing a purchase transaction by the customer (e.g., in the instance that it is determined the customer has a guilty expression).

In accordance with embodiments, a stress level of a customer may be detected. A stress level of a customer may be detected in any suitable way. For example, techniques for detecting stress are described in the published article Towards Macro- and Micro-Expression Spotting in Video Using Strain Patterns, by Shreve et al., the content of which is incorporated by reference herein. In some example, the determined stress level may be combined with a determined microexpression and/or action of a customer for determining an action for the POS terminal to implement. Also, the stress level may be used to increase the customer attention level as disclosed herein.

In accordance with embodiments, systems and methods disclosed herein may be applied to retail personnel. For example, images and/or video of a cashier at a POS terminal may be captured and analyzed for determining a microexpression of the cashier. If particular or predetermined expressions of the cashier are determined, the system may modify a customer attention level and/or implement actions. For example, if the cashier is showing microexpressions indicating fatigue, management can be alerted to give the cashier a break. If the cashier is showing microexpressions indicating anger or frustration, management can be alerted to intervene to alleviate the situation, such as a confrontation with a customer or frustration with their POS system.

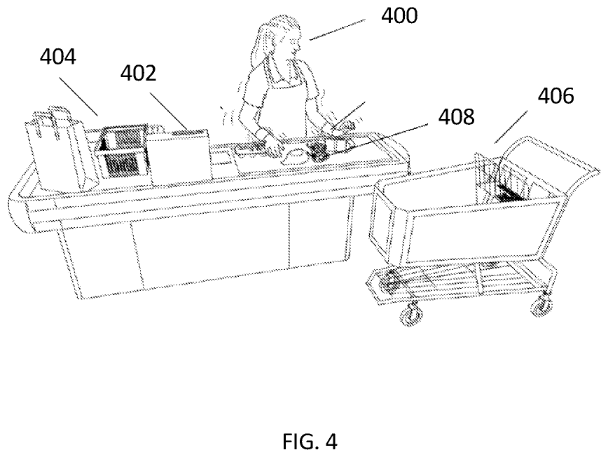

FIG. 4 is a perspective view of an example checkout area with a POS terminal for determining a likelihood of intended purchase of items and for presenting related information to users in accordance with embodiments of the present disclosure. Referring to FIG. 4, a cashier 400 is operating a POS terminal 402 during a POS transaction with a bagging area 404 and a shopping cart 406. The cashier may assist a customer with a purchase transaction for items 408. An image capture device 410 may be positioned for capturing an image of the face of the cashier 400 for determining the cashier's microexpressions in accordance with embodiments of the present disclosure. Also, although a customer is not shown for simplicity of the figure, the image capture device 410 and/or another image capture device may be positioned in the area for capturing an image of the face of the customer for determining the customer's microexpressions in accordance with embodiments of the present disclosure.

In accordance with embodiments, a POS terminal may have two displays: one for retail personnel; and the other for the customer. The customer's display can display advertisements to the customer to lead the customer into purchasing more goods. An image capture device directed to the customer's face may capture the customer's microexpressions in response to the displayed advertisements. By analyzing the customer's direction of eyes to the screen and microexpressions, advertisements can be analyzed or ranked for effectiveness. The analysis information can be used to determine, for example, whether an advertisement is effective, and a time of day to display certain advertisements.

In accordance with embodiments, POS terminals may determine microexpressions of retail personnel to assess for fatigue. For example, the microexpressions may be used to analyze fatigue of a cashier or a mental condition of a cashier. In response to determining a predetermined level of fatigue or a mental condition, a notification or alert to rest may be presented to the cashier or a manager. Further, the system may analyze the cashier's facial microexpression to find cues of fatigue, anger, sadness, or other indicators that may correlate with declining performance compared to a baseline level for the cashier. When one or more such microexpressions are detected that indicate an issue with the cashier, the system may notify a manager so that a decision of letting the cashier take a break can be taken.

The described features, structures, or characteristics disclosed herein may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A method comprising:
acquiring one or more images of a person at a purchase transaction terminal;
analyzing the one or more images to determine an expression of the person;
determining whether the determined expression matches a predetermined expression; and
in response to determining that the determined expression matches the predetermined expression, modifying a customer attention level associated with the purchase transaction terminal.

2. The method of claim 1, wherein the expression is a microexpression.

3. The method of claim 1, wherein modifying the customer attention level comprises increasing or decreasing the customer attention level.

4. The method of claim 1, further comprising communicating a notification to an operator based on the determined expression or modified customer attention level.

5. The method of claim 1, wherein the purchase transaction terminal is one of a self-checkout terminal, a kiosk, and a retail personnel-assisted checkout terminal.

6. The method of claim 1, wherein the predetermined expression is one of a guilty expression, scared expression, and a confused expression.

7. The method of claim 1, further comprising determining an action of the person, and
wherein modifying the customer attention level comprises modifying the customer attention level based on the determined action and the determined expression of the person.

8. The method of claim 1, wherein the customer attention level is an indicator of one or more actions to be taken during a purchase transaction with a customer, and
wherein the method further comprises implementing, during a purchase transaction with the person, the one or more actions associated with the modified customer attention level.

9. The method of claim 8, wherein a number is associated with the person and is indicative of the customer attention level among a plurality of customer attention levels,
wherein the method comprises changing the number of the person based on the expression of the person.

10. The method of claim 1, wherein determining the expression comprises determining whether the person has a guilty expression,
wherein modifying the customer attention level comprises increasing the customer attention level for the person, and
wherein the method comprises increasing a requirement for completing a purchase transaction by the person in response to determining that the person has a guilty expression.

11. A system comprising:
an image capture device configured to acquire one or more images of a person at a purchase transaction terminal; and
a transaction manager configured to:
analyze the one or more images to determine an expression of the person;
determine whether the determined expression matches a predetermined expression; and
modify a customer attention level associated with the purchase transaction terminal in response to determining that the determined expression matches the predetermined expression.

12. The system of claim 11, wherein the expression is a microexpression.

13. The system of claim 11, wherein the transaction manager is configured to increase or decrease the customer attention level.

14. The system of claim 11, wherein the transaction manager is configured to communicate a notification to an operator based on the determined expression or modified customer attention level.

15. The system of claim 11, wherein the purchase transaction terminal is one of a self-checkout terminal, a kiosk, and a retail personnel-assisted checkout terminal.

16. The system of claim 11, wherein the predetermined expression is one of a guilty expression, scared expression, and a confused expression.

17. The system of claim 11, wherein the transaction manager is configured to:
determine an action of the person; and
modify the customer attention level based on the determined action and the determined expression of the person.

18. The system of claim 11, wherein the customer attention level is an indicator of one or more actions to be taken during a purchase transaction with a customer, and
wherein the transaction manager is configured to implement, during a purchase transaction with the person, the one or more actions associated with the modified customer attention level.

19. The system of claim 18, wherein a number is associated with the person and is indicative of the customer attention level among a plurality of customer attention levels,
wherein the transaction manager is configured to change the number of the person based on the expression of the person.

20. The system of claim 11, wherein the transaction manager is configured to:
determine the expression comprises determining whether the person has a guilty expression;
increase the customer attention level for the person; and
increase a requirement for completing a purchase transaction by the person in response to determining that the person has a guilty expression.
